(19) United States
(12) Patent Application Publication
(10) Pub. No.: US 2014/0360794 A1
(43) Pub. Date: Dec. 11, 2014

(54) Snorkel Apparatus and Method of Use for All-Terrain Vehicles

(71) Applicant: Kyle Tallman, Waxahachie, TX (US)

(72) Inventor: Kyle Tallman, Waxahachie, TX (US)

(21) Appl. No.: 13/913,536

(22) Filed: Jun. 10, 2013

(51) Int. Cl. B60K 13/02

(52) U.S. Cl. CPC B60K 13/02
USPC 180/68.3

(57) ABSTRACT

A snorkel for allowing an all-terrain vehicle (ATV”) to travel while at least partially submerged, avoid entanglements with foliage and maintain consistent appearance even after the snorkel tubes are extensively scratched.

### TECHNICAL FIELD OF THE INVENTION

The present disclosure relates generally to a snorkel kit for all-terrain vehicles (ATVs), allowing them to function with their engine underwater.

### BACKGROUND OF THE INVENTION

Since at least the 1950s, specialty vehicles have been equipped with snorkels to allow them to travel while underwater, either in whole or in part. These snorkels are affixed to the intake manifold of combustion engines and extend to a height above the motor so it can operate while submerged.

As opposed to military vehicles which are produced in number to a specific design, casual ATV recreation users tend to be highly individualized, with vehicle owners installing after-market kits that require considerable modification to the vehicle on which the installation is occurring. Users prefer installations that require minimal changes to the vehicle to maintain resale value, while providing individualization.

Users also struggle with snorkel kits which are made of inexpensive polyvinyl chloride (PVC) pipes. PVC pipe do not appear to be an organic part of the vehicle. When damaged or even scratched, the white of the PVC piping is revealed, which is unsightly and therefore undesirable.

Even with a snorkel kit, water splashes up and into the intake of the pipes (the raised end opposite of the end connected to the motor), causing the motor to sputter and even fail.

The industry needs high quality snorkel kits that blend with the ATVs to appear as organic parts of the vehicle as it comes from a manufacturer, can be scratched without changing color or revealing itself to be inexpensive PVC pipe, and which resists water splash into the intake end of the snorkel pipe.

### SUMMARY OF THE INVENTION

The present disclosure provides a snorkel kit and method of use to modify an all-terrain vehicle so that the vehicle can travel in the water in deeper water than would otherwise be possible.

This particular snorkel kit differs from others in the market which uses black Schedule 40 polyvinyl chloride (PVC) pipe. Many other organizations use PVC piping, but the invention at bar uses black Schedule 40 PVC, which has not been used previously.

One key issue in this invention is that the PVC piping used in the riser is actually black throughout, rather than white PVC that is painted a different color, which is the product typically used to build these products.

Another positive difference is the smoother appearance of the pipe's Schedule 40 piping than the more clunky appearance found in other types of PVC.

On top of the differing materials and schedules, the disclosed invention can include an optional water-repulsive screen at the opening of the snorkel's raised intake pipe through which water and debris could otherwise travel and destroy or disable the ATV's motor.

The disclosure included with this application is one embodiment as installed on the 2012-13 Arctic Wildcat 1000, but this is merely one embodiment, and there are many other embodiments for the Arctic Wildcat 1000 and other ATVs, each of which requires similar gear and steps of invention.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 depicts an orthogonal view of the snorkel riser assembly when installed.

FIG. 2 depicts a rear view of a vehicle with the invention installed.

FIG. 3A is an orthogonal front view of an optional splash guard.

FIG. 3B is a top view of the optional splash guard.

FIG. 3C is a front view of the optional splash guard.

FIG. 3D is a side view of an optional splash guard.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

Unless otherwise stated, all of the drawings and discussion concern piping that has a 2″ internal diameter. Other diameters would work just as well and the invention is not limited to 2″ piping, but the current embodiment employs 2″ piping.

All of the PVC tubing discussed is black Schedule 40 PVC, manufactured by special order for the inventor. The PVC material itself is black, rather than just paint on white PVC. The advantage of this material is that the invention maintains its color even when accidents occur which might result in nicks in the PVC. All identified prior art uses white PVC.

The PVC tubing used in this invention also differs from prior art by use of Schedule 40 PVC, which has not previously been employed. Schedule 40 PVC has physical characteristics that avoid entanglement with vines or other foliage because it is devoid of the sharp edges and bulky shape found in common plumbing PVC connections. Schedule 80 PVC is similar, but the current embodiment employs the Schedule 40 piping.

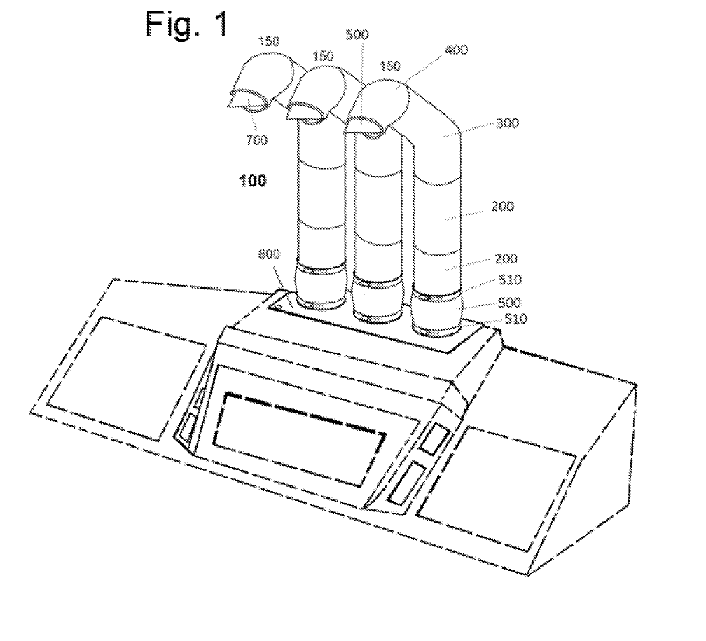

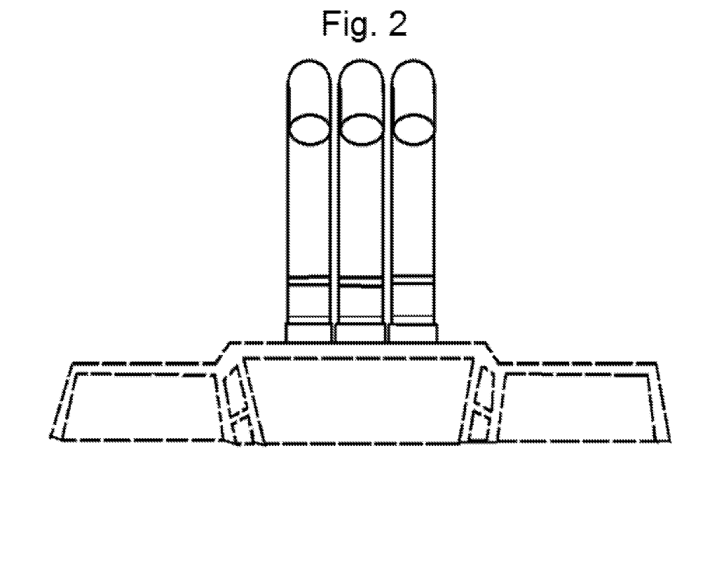

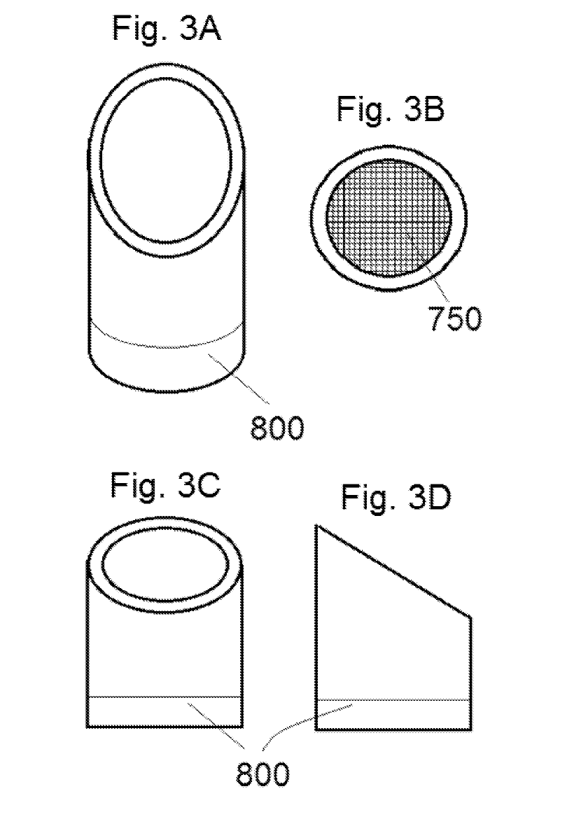

FIG. 1 depicts a triple-tubed snorkel Riser Assembly 100, consisting of three Riser Subassemblies 150. Each of the Riser Subassemblies 150 comprise PVC pieces that are attached to exhaust or air intake assemblies that extend through a modified Radiator Cover 600 and connect to the Riser Subassemblies 150 by Rubber Couplings 500 (Fernco 1056-22).

The Rubber Coupling 500 has two open ends; the lower of the ends is connected to an air intake or exhaust piping leading to the vehicle motor, while the Coupling's upper end is connected to a section of Straight Section 200. Hose Clamps 510 connect the Rubber Coupling 500 to the unseen piping below and the Riser Subassemblies 150 above the Radiator Cover 600.

As shown in FIG. 1, a 45-Degree Elbow 300 is connected to the straight black Schedule 40 PVC 200, and then a 90-Degree Elbow 400. To complete the Riser Subassembly 150, a Slip Coupling 500 is cut at 45 degrees on one end, oriented so the opening of the Coupling 500 is parallel to the ground, and then glued in the end of the 90-Degree elbow 400.

Alternatively, an optional Splash Guard 700 can take the place of the Slip Coupling 500. The Splash Guard 700 is the same size as the Slip Coupling, but has a Mesh Screen 750 (installed at the level marked with numeral 800). The Mesh Screen 750 dissuades water entry into the tube.

Because the Riser Subassembly's opening is parallel to the ground, the invention is water resistant in several ways; rain cannot enter the tube, and if the vehicle on which the Snorkel 100 is installed happens to momentarily slip below water, water would still not be able to enter the tube.

There are many methods of running piping for a snorkel that have been employed for the last fifty years; this invention does not claim all ATV snorkels, but only snorkels on ATVs that include the prior-discussed traits.

Similar embellishments, and various combinations thereof, are all comprehended by the present disclosure. All embodiments described herein are presented for purposes of illustration and explanation only. The specific compositions, configurations, which may be provided in a number of ways in accordance with the present disclosure. A set of installation instructions are provided with this application as an example only of one type of snorkel installation. The applicant maintains that any person having ordinary skill in the art can install a snorkel on an ATV—the patentable portion of the invention is the riser construction and splash guard.

What is claimed is:

1. A snorkel for an all-terrain vehicle (“ATV”), comprising: one or more (polyvinyl chloride) PVC pipes which run from the ATV engine through the body of the ATV, and extend vertically above the ATV's engine, each snorkel tube comprising black Schedule 40 PVC piping.

2. A snorkel as in claim one, in which the raised open ends of the snorkel tubes include a turn in the upper end of the tube such that the snorkel tube opening is parallel to the ground.

3. A snorkel as in claim one, with an optional mesh screen installed near the raised end of the snorkel tube.
